(19) United States
(12) Patent Application Publication
(10) Pub. No.: US 2014/0067963 A1
(43) Pub. Date: Mar. 6, 2014

(54) DYNAMIC MULTIMODAL VISUAL MESSAGE PRIORITIZATION METHOD AND APPARATUS

(71) Applicant: David L. Chavez, Broomfield, CO (US)

(72) Inventor: David L. Chavez, Broomfield, CO (US)

(73) Assignee: AVAYA INC., Basking Ridge, NJ (US)

(21) Appl. No.: 13/599,774

(22) Filed: Aug. 30, 2012

(51) Int. Cl. G06F 15/16

(52) U.S. Cl. 709/206

(57) ABSTRACT

Methods and systems for providing a depiction of the relative importance of messages directed to a user of a multimodal communication endpoint are provided. More particularly, message indications are placed within a schema having two or more dimensions, depending on a determined classification or importance. Accordingly, the location, and optionally other attributes, of the message indication provides distinguishing characteristics that communicate a relative importance and/or relevance of a message to a user.

### FIELD

The present disclosure is directed to systems and methods for dynamic multimodal visual message prioritization.

### BACKGROUND

Communication devices that handle multiple types of communications are increasingly common. Although the availability of multiple communication modes gives users great flexibility in conducting communications, managing multiple message types can be difficult.

For example, a typical smart phone supports various types of communications in addition to voice telephony. For example, email, text messaging, and messaging via social networks can be supported. Moreover, smart phones can provide indications to a user when voicemail messages are waiting to be accessed. Techniques for organizing or prioritizing messages have been developed. However, such techniques have typically not applied to multiple communication modes. For example, email systems commonly allow users to direct email messages to different mailboxes or folders, depending on characteristics of the received email. Other systems provide for grouping of messages having common themes. Still other techniques have presented content using a grid of tiles that can be refreshed individually. More particularly, the individual tiles illustrate different messages or information sources. However, there is no provision in such systems for intermingling messages of different types. Moreover, such techniques do not satisfactorily achieve the goal of providing a convenient and readily understood depiction of messages from multiple sources and the priority thereof.

### SUMMARY

Systems and methods that provide a graphical indication of the relative priority or importance of messages associated with different communication modes are provided. More particularly, a user interface that provides a graphical view or depiction of messages directed to a user is provided. The graphical representation can include a depiction of messages that arranges the messages in a multidimensional format. Moreover, the location of a message within the graphical representation, and relative to other messages, can provide a ready indication to the user of the relative importance of the message.

In accordance with at least some embodiments of the present disclosure, the user interface presents an “archery target” design, in which the different concentric circles provide different locations in which to provide a visual indication of a message. The messages included within a particular ring can be of different message types. However, the messages within a particular ring can share a common classification as to priority or importance. Continuing the example of an archery target type embodiment, a user can identify messages as being more important the closer they are to the center of the target.

Systems in accordance with at least some embodiments of the present disclosure include a communication device. Moreover, the communication device can be capable of supporting multiple communication modes. In addition, the communication device includes a display capable of depicting information to a user visually. In particular, the display can present an indication of multiple messages to the user simultaneously. Moreover, the display can arrange the visual indicators of different messages such that the position of a visual indicator within the user interface indicates a classification or priority of the associated message. In accordance with still further embodiments, the user may provide user input through a facility of the communication device, to select a message indication, and to respond to, access, or otherwise interact with the related message.

Additional features and advantages of embodiments of the present disclosure will become more readily apparent from the following description, particularly when taken together with the accompanying drawings.

### BRIEF DESCRIPTION OF THE DRAWINGS

FIG. 1 is a block diagram depicting components of a system in accordance with embodiments of the present disclosure;

FIG. 2 is a block diagram depicting components of a communication endpoint in accordance with embodiments of the present disclosure;

FIG. 3 depicts a user interface in accordance with embodiments of the present disclosure; and

FIG. 4 is a flowchart depicting aspects of a method in accordance with embodiments of the present disclosure.

### DETAILED DESCRIPTION

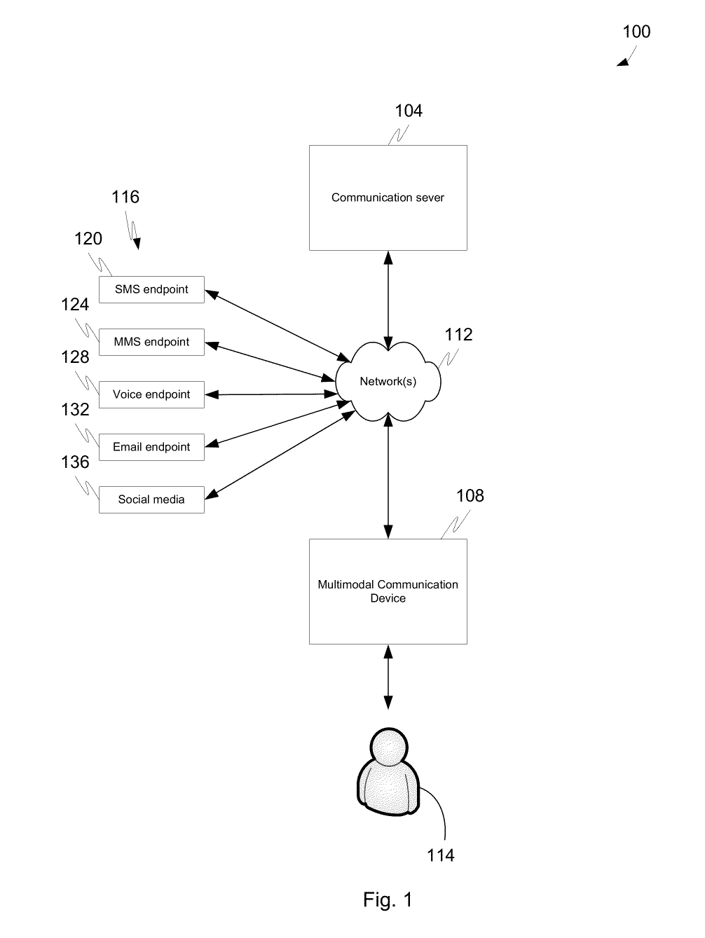

FIG. 1 is a block diagram depicting components of a communication system 100 in accordance with embodiments of the present disclosure. In general, the communication system 100 includes one or more communication servers 104. The communication server 104 is interconnected to a multimodal communication device 108 via one or more communication networks 112. A user 114 is associated with the multimodal communication device 108. The system 100 also includes a variety of additional communication endpoints 116, of various types, which can operate to engage in communications with the multimodal communication device 108 via one or more of the networks 112, and/or the communication server 104.

The communication server 104 can provide communication services to client devices, including but not limited to the multimodal communication device 108. As an example, a communication server 104 may comprise an enterprise server that routes communications addressed to the multimodal communication device 108 when such device 108 is available, and/or stores such messages for later retrieval by the multimodal communication device 108 or an affiliated device of the user 114. Accordingly, a communication server 104 may comprise a telephony server, an email server, a text messaging server, a multimedia server, a social media server, or the like. Moreover, a single communication server 104 can provide support to a multimodal communication device 108 with respect to a plurality of communication modes. As a further example, some or all of the communication servers 104 operating in support of a multimodal communication device 108 may support a single communication mode. Moreover, multiple communication servers 104 may operate in series. For example, a first communication server 104 may provide support to a multimodal communication device 108 for communications of various modes over a cellular network, which can be used to deliver voice telephony communications received from a second communication server 104 comprising a voice telephony server, email communications from a third communication server 104 comprising a mail server, and social network messages from a fourth communication server 104 comprising a social network server. In addition, different communication servers 104 or combinations of communication servers 104 may operate in connection with a multimodal communication device 108 at different times. For instance, a first communication server 104 may operate in connection with a first network 112 comprising a cellular telephony network to support voice communications, at the same time that a second communication server 104 in connection with a second network 112 comprising an IP data network supports email and other data transmitted across the IP network.

The multimodal communication device 108 generally supports multiple message types. In general, the messages are directed to or associated with the user 114 of the multimodal communication device 108. In an exemplary embodiment, the multimodal communication endpoint 108 comprises a mobile communication device capable of wireless communications over one or more networks 112. Accordingly, in an exemplary embodiment, a multimodal communication endpoint 108 is a smart phone. However, embodiments of the present disclosure can be used with any communication endpoint 108 capable of supporting multiple communication modes and of providing graphical user interface to a user, including static endpoints. Therefore, other examples of a multimodal communication endpoint 108 include a desktop computer, a laptop computer, a tablet computer, a set top box, or the like.

The different message endpoints 116 represent endpoints that may engage in communications with the multimodal communication device 108. Accordingly, examples include short message service (SMS) 120, multimedia messaging service (MMS) 124, voice telephony 128, email 132, and social media 136 endpoints or sources. Such endpoints or sources 116 may comprise stand alone devices and/or multimodal devices. Such endpoints or sources 116 are also typically associated with a user, however this is not necessarily the case. For example, an endpoint 116 may comprise an automated device, such as an interactive voice response (IVR) system.

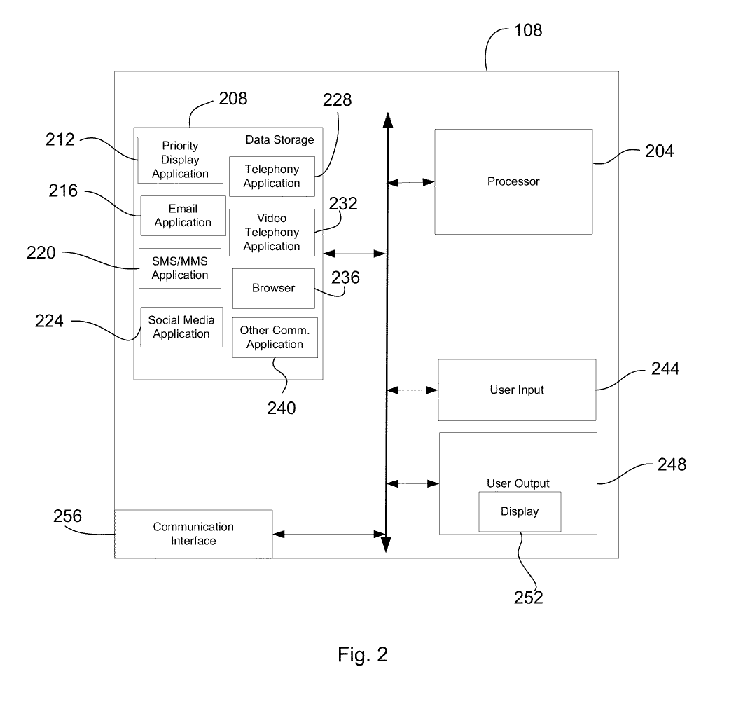

FIG. 2 is a block diagram depicting a multimodal communication endpoint 108 in accordance with embodiments of the present disclosure. The multimodal communication endpoint 108 includes a processor 204 capable of executing program instructions. The processor 204 can include any general purpose programmable processor or controller for executing application programming. Alternatively, the processor 204 may comprise a specially configured application specific integrated circuit (ASIC). The processor 204 generally functions to run programming code implementing various functions performed by the multimodal communication endpoint 108. For example, the processor 204 can implement functions including the classification and display of message notifications or indications as described herein.

The multimodal communication endpoint 108 also generally includes memory 208. The memory 208 can be used in connection with the execution of programming by the processor 204, and for the temporary or long term storage of data or program instructions. For example, the memory 208 can provide for the storage of a priority display application 212 that classifies, determines a location within a display at which to present an indication of a message, and controls operation of the user interface as described herein. As additional examples, the memory 208 can provide storage for an email application 216, an SMS/MMS application 220, a social media application 224, a telephony application 228, a video telephony application 232, a browser 236, or other communication applications 240. The memory 208 can include solid state memory that is resident, removable, and/or remote in nature, such as DRAM and SDRAM. Alternatively or in addition, the memory 208 can include magnetic, optical, or other storage devices. Moreover, the memory can include a plurality of discrete components of different types and/or a plurality of logical partitions.

In addition, the multimodal communication endpoint 108 includes one or more user input devices 244, and one or more user output devices 248. Examples of user input devices 244 include a keyboard, a numeric keypad, touch screen, microphone, and pointing device combined with a screen or other position encoder. In accordance with embodiments of the present invention, the user output includes a visual display 252, such as but not limited to a liquid crystal display. Moreover, the display 252 may be capable of presenting two-dimensional and/or three-dimensional images. The display 252 may also be combined with a user input 244 to provide a touch screen display. Other examples of user output devices 248 include a speaker and indicator lamps.

A multimodal communication endpoint 108 also includes one or more communication interfaces 256. In general, a communication interface 256 supports communications between the multimodal communication endpoint 108 and another endpoint or source 116, and/or a communication server 104, via a network 112. Moreover, examples of communication interfaces 256 include both wire line and wireless interfaces. Accordingly, examples of communication interfaces 256 include a circuit switched or plain old telephony system, Ethernet, Wi-Fi, cellular telephony, satellite telephony, Bluetooth, or the like.

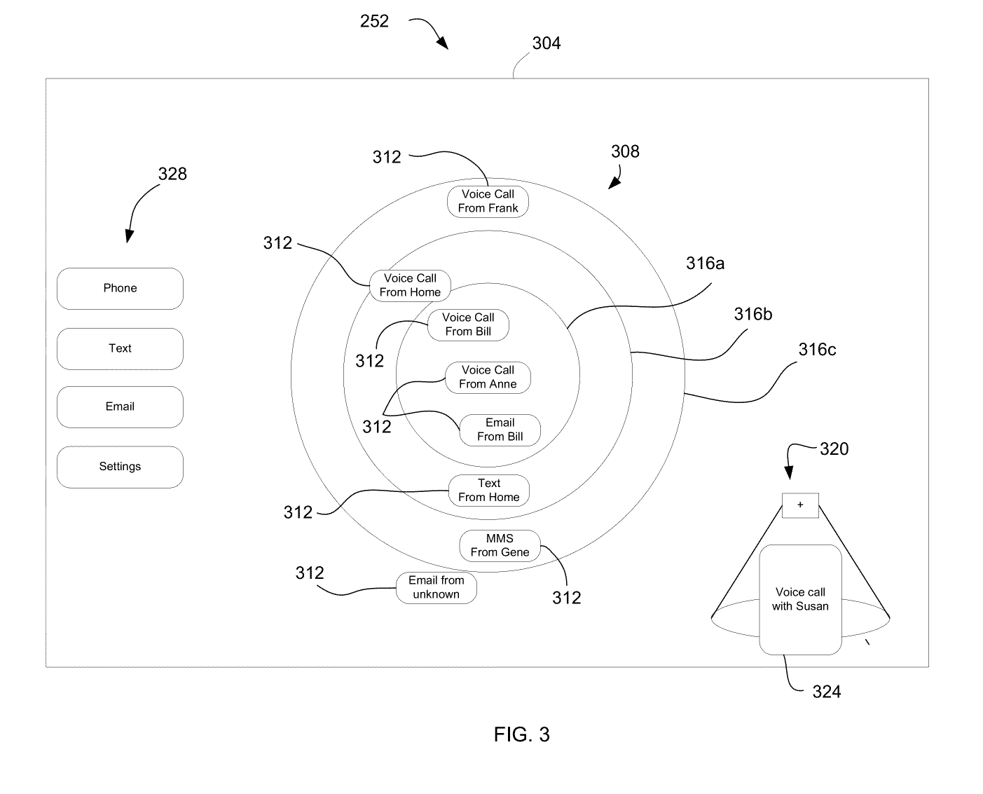

With reference now to FIG. 3, a user interface 304, such as can be presented by the display 252 of a multimodal communication endpoint 108 operating a priority display application 212 as described herein is depicted. In general, the user interface 304 provides a graphical depiction that includes a multidimensional framework or schema 308 for presenting a plurality of message indications 312. Moreover, the multidimensional schema 308 may represent different classifications of message indications 312. For example, as depicted in FIG. 3, the schema 308 can comprise a plurality of concentric rings, where each ring is associated a different message classification. Alternatively or in addition, a relative classification or prioritization between individual message indications 312 can be provided. For example, a message indication 312 that is closer to the center of the concentric circles of the schema 308 indicates that the associated message is more important or has received a higher level classification than a message associated with a message indication 312 that is farther from the center of the schema 308. In the exemplary schema 308, the different bands created by the different concentric rings 316 represent different classification assignments of messages pending action by the user 114. For instance, the center ring or circle 316a can be reserved for indications associated with messages from the user's 114 workplace. The second ring 316b can be associated with messages from the user's 114 family. The outer ring 316c can contain indications 312 associated with messages from the user's 114 friends or other contacts. Indications of messages 312 outside of the outermost ring 316c may be associated with messages from unidentified contacts. Accordingly, in this exemplary schema 308, proximity to the center of the concentric rings 316 indicates a degree of importance or the classification rank assigned to a message associated with the indication 312. Moreover, while relative position can indicate relative importance, the provision of graphical depictions of different classes can assist a user 114 in readily identifying the class assigned to a message associated with a message indication 312. In accordance with still other embodiments, the schema 308 is not limited to two dimensions. For example, a display 252 capable of rendering three dimensions can be used. In such embodiments, the third dimension, for example represented by the relative apparent height of the message indication 312 from the background of the user interface 304 can indicate an urgency associated with a message represented by a message indication 312. Alternatively or in addition, message indications 312 can be provided in different colors, fonts and the like, to provide additional information discriminating between associated messages to the user 114.

The user interface 304 can also provide for controls that enable the user 114 to interact with or concerning messages associated with message indications 312. For example, a spotlight or active area 320 can be provided to initiate actions and/or to indicate a current activity. Thus, in the illustrated example, the activation area 320 indicates that the multimodal communication endpoint 108 is currently engaged in a voice call with “Susan” 324. The activation area 320 can also be used to facilitate the handling of messages associated with message indications 312. For example, a user 114 can enter input, such as tapping and dragging a message indication 312 to the activation area 320, in order to answer a message comprising a call, access a voicemail, read the text of a message and launch a reply to the message, and the like. Other controls 328 can also be provided, for example to initiate communications utilizing various modes without necessarily referencing a message associated with a message indication 312.

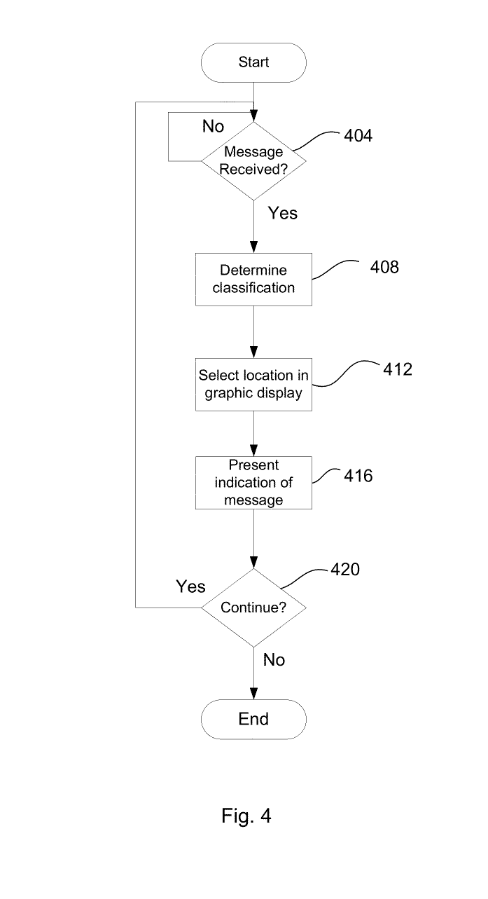

With reference now to FIG. 4, aspects of a method in accordance with embodiments of the present disclosure are depicted. Initially, at step 404, a determination is made as to whether a message has been received with respect to a multimodal communication endpoint 108. As used herein, the receipt of a message can include the notification that a message addressed or otherwise directed to the multimodal communication endpoint 108 is available. Accordingly, a message may be received in the form of a ring associated with a telephony call, a notification that an email, voicemail, or other data is available for retrieval from a communication server 104, a text message is received, or the like. In general, the process idles at step 404 until a message has been received.

Once a message is received, a classification of the message is determined (step 408). For example, the priority display application 212 may operate to determine the classification of the message. Determining the classification of a message can include implementing a rules engine for providing an assignment of the message to a predefined classification, or to assign a classification or priority of the message relative to other messages pending handling by the user 114. The classification can be assigned by the rules engine in various ways. For instance, a classification or priority may be assigned by some other entity of authority, such as the communication server 104, or a sending device 116. Alternatively or in addition, a classification or priority can be determined by information or metadata associated with the message. For instance, the name of the sender, domain of the sender, time of the message, content of the message, whether the message is from a human or non-human source or sender, or any other characteristic included in or associated with the message can be utilized in order to determine the classification assigned to the message by the priority display application 212.

At step 412, a location for the message indication 312 associated with the receipt of a message within the schema 308 is selected (step 412). For instance, where the schema 308 provides different distinct areas in which message indications 312 can be displayed, one of those areas can be selected by the priority display application 212, in view of the determined classification, for presenting the message indication 312. Moreover, where multiple message indications 312 are presented by a user interface 304 simultaneously, the priority display application 212 can also determine a position or location in which to present a particular message indication 312, relative to other message indications 312. For instance, the relative distance to the center of the schema 308 can provide a representation of a relative importance of a message associated with a message indication 312. Proximity to different axes can also be used. For instance, proximity to a vertical axis that extends through the center of the schema 308 can be reserved for relatively more important message indications 312. Moreover, in addition to a location, other aspects of the message indication 312 can be selected in order to indicate a classification or prioritization of a message. For example, a bright color, bold type, or other feature can be selected in view of the determined classification. The indication of the message 312 can then be presented at the selected location, and with any other selected attributes (step 416). At step 420, a determination can be made as to whether operation of the priority display application 212 is to be continued. If operation is to be continued, the process can return to step 404, to await receipt of an additional message or notification of a message. Alternatively, the process can end.

As can be appreciated by one of skill in the art after consideration of the present disclosure, methods and systems that facilitate the identification of messages requiring prioritized handling by a user 114 are provided. Although certain examples that include the use of multiple concentric circles have been discussed, other schemas 308 in accordance with embodiments of the present disclosure can be utilized. For instance, any graphically depicted topography, in which a relative location of a message indication 312 signifies relative importance of an associated message can be utilized. For example, the topography can be in the form of a map in which different locations or regions are utilized for message indications 312 having different determined classifications. A schema can also include regions, locations and/or rings that are reserved for message indications 312 associated with messages that are from a non-human source, such as automatic notifications. Accordingly, any schema 308 in which message indications 312 are presented in two or more dimensions can be utilized.

In addition, although embodiments in which a priority display application 212 is executed in a multimodal communication device 108 have been discussed, other configurations are possible. For example, a priority display application 212 can be executed by a communication server 104, or other device or server on behalf of a multimodal communication endpoint 108. Moreover, different users 114 can be associated with different rules engines and/or priority schemes that determine the presentation of message indications 312 by the priority display application 212 on a display 252.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method of providing a representation of messages, comprising:
receiving a first message at a first communication device;
determining a classification for the first message;
based on the determined classification for the first message, selecting a location in a graphic display in which to place a visual indication of the first message.

2. The method of claim 1, further comprising:
receiving a second message at the first communication device;
determining a classification for the second message;
based on the determined classification for the second message, selecting a location in the graphic display in which to place a visual indication of the second message.

3. The method of claim 2, wherein the visual indication of the first message and the visual indication of the second message are in different locations in the graphic display.

4. The method of claim 3, wherein the different locations are indicative of the first message receiving a different classification than the second message.

5. The method of claim 4, further comprising:
displaying the first message in the selected location for the first message;
displaying the second message in the selected location for the second message.

6. The method of claim 5, wherein the graphic display includes a two dimensional display.

7. The method of claim 6, wherein the two dimensional display includes a target with multiple concentric rings, wherein the determined classification for the first message has a higher priority than the determined classification for the second message, wherein the visual indication of the first message is located within a ring that includes or is near the center of the target, and wherein the visual indication of the second message is located within a ring that is farther from the center than the visual indication of the first message.

8. The method of claim 7, wherein the determined classification is based at least in part on a sender of the message.

9. The method of claim 8, further comprising:
receiving a third message at the first communication device;
determining a classification for the third message;
based on the determined classification for the third message, selecting a location in the graphic display in which to place a visual indication of the third message,
wherein the third message is from a sender having the same classification as the sender of the first message, and
wherein the visual indication of the first message is in the same ring as the visual indication of the third message.

10. The method of claim 9, wherein the sender of the first message is the same as the sender of the third message.

11. The method of claim 9, wherein the first message is of a first message type, and wherein the third message is of a second message type.

12. The method of claim 11, wherein the first message is a first one of a voice mail message, a missed call message, an email, a short message system message, a multimedia messaging service message, and a social media message.

13. The method of claim 6, wherein the two-dimensional display is a map, wherein the first message has a higher priority than the determined classification for the second message, wherein the visual indication of the first message is located within a first region of the map, and wherein the visual indication of the second message is located within a second region of the map.

14. The method of claim 3, wherein the determined classification for the second message is associated with a non-human source, and wherein the location of the visual indication of the second message is reserved for messages associated with the non-human source.

15. A communication system, comprising:
a communication device, including:
a display;
memory;
a processor, wherein the processor executes application programming stored in the memory, wherein the application programming is operable to display a visual indication of a first message received at the communication device and having a first classification in a first location within the display, and wherein the application programming is operable to display a visual indication of a second message received at the communication device and having a second classification in a second location within the display.

16. The communication system of claim 15, further comprising:
a first communication network;
at least a first communication server, wherein at least the first message is provided to the communication device by the first communication server over the first communication network;
a second communication network, wherein the second message is provided to the communication device by at least one of the first communication server and a second communication server over the second communication network.

17. The method of claim 16, wherein the display presents a series of concentric rings, wherein the visual indication of the first message is in a first ring, wherein the visual indication of the second message is in a second ring, and wherein the first ring is closer to a center of the series of concentric rings than is the second ring.

18. A computer readable medium having stored thereon computer executable instructions, the computer executable instructions causing a processor to execute a method for displaying messages to a user of a mobile device, the computer executable instructions comprising:
instructions to determine a classification of messages received at or available to the mobile device;
instructions to present a visual indication of the messages received at or available to the mobile device in a display of the mobile device, wherein the visual indications of the messages are displayed in selected locations within the display of the mobile device, wherein for each visual indication a selected location depends at least in part on the determined classification for the associated message.

19. The computer readable medium of claim 18, wherein a first received or available message and a second received or available message included in the messages received at or available the mobile device are determined to have first and second classifications respectively, wherein a selected location for the visual indication of the first message is within a first area of the display, wherein a selected location for the visual indication of the second message is within a second area of the display, and wherein the first and second areas of the display are graphically distinguished from one another.

20. The computer readable medium of claim 19, wherein the first received or available message is of a first type and is from a first sender, and wherein the second received or available message is of a second type and is from a second sender.
